(19) United States
(12) Patent Application Publication
(10) Pub. No.: US 2026/0185824 A1
(43) Pub. Date: Jul. 2, 2026

(54) TIRE GROOVE MEASURING DEVICE, TIRE GROOVE MEASURING SYSTEM, AND TIRE GROOVE MEASURING METHOD

(71) Applicant: PERSOL AVC TECHNOLOGY CO., LTD., Takatsuki City, Osaka (JP)

(72) Inventors: Kazuhiro UMEZAWA, Takatsuki City, Osaka (JP); Nobumichi TAKABA, Takatsuki City, Osaka (JP); Takaya KANO, Takatsuki City, Osaka (JP); Masayuki MIZUNO, Takatsuki City, Osaka (JP); Nobuo MORITANI, Takatsuki City, Osaka (JP); Hayato HEMMI, Takatsuki City, Osaka (JP); Kazuyuki MATSUMOTO, Takatsuki City, Osaka (JP); Shinobu NOTO, Takatsuki City, Osaka (JP); Ryutaro SEITA, Takatsuki City, Osaka (JP); Tomokazu TANAKA, Takatsuki City, Osaka (JP); Keisuke IKEMORI, Takatsuki City, Osaka (JP)

(21) Appl. No.: 19/125,575

(22) PCT Filed: Oct. 31, 2022
(86) PCT No.: PCT/JP2022/040676

§ 371 Date: Apr. 29, 2025

(51) Int. Cl. G01B 11/22; G01B 11/24; G01M 17/02

(52) U.S. Cl. CPC G01B 11/22; G01B 11/24; G01M 17/027

(57) ABSTRACT

A hand-held tire groove measuring device includes a distance sensor that detects a distance between a tire and the tire groove measuring device, and a processing device that generates contour shape data representing a contour shape of the tire based on output data of the distance sensor. The processing device is configured to: detect main grooves based on the contour shape data; delete portions of the contour shape data corresponding to the main grooves; interpolate the deleted portions corresponding to the main grooves in the contour shape data whose portions corresponding to the main grooves have been deleted, thereby generating trajectory data representing a trajectory of movement of the tire groove measuring device; compare the trajectory data with reference shape data representing a contour shape of a reference tire prepared in advance to generate hand shake component data representing a hand shake component; and correct the contour shape data before deletion of the portions corresponding to the main grooves using the hand shake component data.

### TECHNICAL FIELD

The present invention relates to a tire groove measuring device, a tire groove measuring system, and a tire groove measuring method.

### BACKGROUND ART

Tires mounted on vehicles such as automobiles have grooves in their treads. As the tire wears as the vehicle runs, the depths of the grooves become shallower, and therefore, there is a need to measure the depths of the grooves and manage the condition of the tire.

Patent Document No. 1 discloses a measuring device for measuring the grooves on a tire tread. The measuring device is fixed to the ground as a car stop in a parking space. Patent Document No. 1 discloses a technique for measuring tire grooves while a vehicle is parked so that the tire contacts the measuring device, which is a car stop.

### CITATION LIST

### Patent Literature

Patent Document No. 1: Japanese Laid-Open Patent Publication No. 2019-086293

### SUMMARY OF INVENTION

### Technical Problem

Since the measuring device of Patent Document No. 1 is fixed to the ground, the measurement of grooves can only be performed at the location where the measuring device is installed. It is also necessary to move the vehicle so that the tire is positioned in a predetermined position at a predetermined angle. Patent Document No. 1 fails to disclose how to process the output data of the laser displacement sensor that measures the tire grooves to manage the grooves.

There is a need to improve user convenience with respect to the measurement of tire grooves.

### Solution to Problem

A tire groove measuring device according to an embodiment of the present invention is a hand-held tire groove measuring device that a user moves along a tread of a tire to be measured for measuring grooves provided in the tread of the tire, including: a distance sensor that detects a distance between the tire and the tire groove measuring device; and a processing device that generates contour shape data representing a contour shape of the tire based on output data of the distance sensor, wherein: the tread of the tire is provided with main grooves having a wear indicator; and the processing device is configured to: detect main grooves based on the contour shape data; delete portions of the contour shape data corresponding to the main grooves; interpolate the deleted portions corresponding to the main grooves in the contour shape data whose portions corresponding to the main grooves have been deleted, thereby generating trajectory data representing a trajectory of movement of the tire groove measuring device; compare the trajectory data with reference shape data representing a contour shape of a reference tire prepared in advance to generate hand shake component data representing a hand shake component; and correct the contour shape data before deletion of the portions corresponding to the main grooves using the hand shake component data.

A tire groove measuring system according to an embodiment of the present invention is a tire groove measuring system using a hand-held tire groove measuring device that a user moves along a tread of a tire to be measured for measuring grooves provided in the tread of the tire, including: a distance sensor that detects a distance between the tire and the tire groove measuring device; and a processing device that generates contour shape data representing a contour shape of the tire based on output data of the distance sensor, wherein: the tread of the tire is provided with main grooves having a wear indicator; and the processing device is configured to: detect main grooves based on the contour shape data; delete portions of the contour shape data corresponding to the main grooves; interpolate the deleted portions corresponding to the main grooves in the contour shape data whose portions corresponding to the main grooves have been deleted, thereby generating trajectory data representing a trajectory of movement of the tire groove measuring device; compare the trajectory data with reference shape data representing a contour shape of a reference tire prepared in advance to generate hand shake component data representing a hand shake component; and correct the contour shape data before deletion of the portions corresponding to the main grooves using the hand shake component data.

A tire groove measuring method according to an embodiment of the present invention is a tire groove measuring method using a hand-held tire groove measuring device that a user moves along a tread of a tire to be measured for measuring grooves provided in the tread of the tire, wherein: the tread of the tire is provided with main grooves having a wear indicator; and the tire groove measuring method includes: detecting a distance between the tire and the tire groove measuring device using a distance sensor; generating contour shape data representing a contour shape of the tire based on output data of the distance sensor; detecting main grooves based on the contour shape data; deleting portions of the contour shape data corresponding to the main grooves; interpolating the deleted portions corresponding to the main grooves in the contour shape data whose portions corresponding to the main grooves have been deleted, thereby generating trajectory data representing a trajectory of movement of the tire groove measuring device; comparing the trajectory data with reference shape data representing a contour shape of a reference tire prepared in advance to generate hand shake component data representing a hand shake component; and correcting the contour shape data before deletion of the portions corresponding to the main grooves using the hand shake component data.

### Advantageous Effects of Invention

With the hand-held tire groove measuring device, since the user moves the tire groove measuring device by hand when measuring the tire, a discrepancy may occur between the contour shape data obtained from the output data of the distance sensor and the actual contour shape of the tire.

According to an embodiment of the present invention, trajectory data representing the trajectory of movement of the tire groove measuring device is generated based on the contour shape data obtained from the output data of the distance sensor, and the hand shake component data is generated using the trajectory data. By correcting the contour shape data using the generated hand shake component data, it is possible to reduce the discrepancy between the contour shape data and the actual contour shape of the tire. Thus, it is possible to obtain the contour shape data representing a shape that is closer to the actual contour shape of the tire.

### BRIEF DESCRIPTION OF DRAWINGS

FIG. 1 is a view showing how grooves 40 of a tire 30 are scanned by a tire groove measuring device 1 according to an embodiment of the present invention.

FIG. 2 is a block diagram showing the tire groove measuring device 1 according to an embodiment of the present invention.

FIG. 3 is a flow chart showing the process of correcting contour shape data 50 according to an embodiment of the present invention.

FIG. 4 is a flow chart showing the process of detecting a plurality of main grooves 41 from the contour shape data 50 according to an embodiment of the present invention.

FIG. 5 is a view showing the contour shape data 50 representing the contour shape of a portion of a tread 31 provided with the grooves 40 according to an embodiment of the present invention.

FIGS. 6(a) to 6(c) are views showing the process of calculating the depth of a candidate groove 40 according to an embodiment of the present invention.

FIGS. 7(a) to 7(c) are views showing the scaling process according to an embodiment of the present invention.

FIGS. 8(a) to 8(c) are views showing the process of generating trajectory data 51 according to an embodiment of the present invention.

FIGS. 9(a) to 9(c) are views showing the process of generating hand shake component data 53 according to an embodiment of the present invention.

FIGS. 10(a) to 10(c) are views showing the process of correcting contour shape data 50c according to an embodiment of the present invention.

FIG. 11 is a block diagram showing a tire groove measuring system 100 according to an embodiment of the present invention.

### DESCRIPTION OF EMBODIMENTS

An embodiment of the present invention will now be described with reference to the drawings. Like reference signs denote like elements, and redundant descriptions will be omitted. The following embodiment is illustrative, and the present invention is not limited thereto.

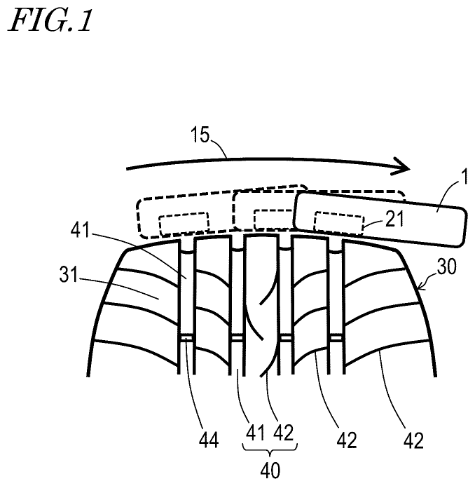

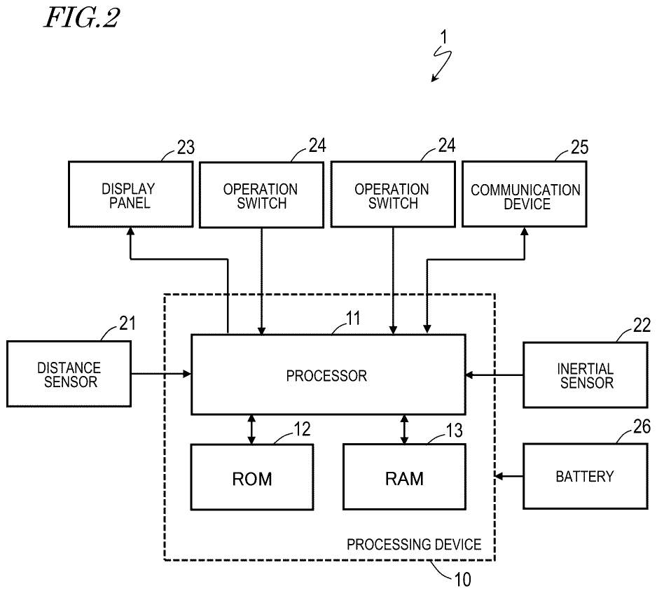

FIG. 1 is a view showing a tire groove measuring device 1 according to an embodiment of the present invention scanning grooves 40 of a tire 30. FIG. 2 is a block diagram showing the tire groove measuring device 1 of the present embodiment.

A plurality of grooves 40 are provided on a tread 31 of the tire 30. The plurality of grooves 40 include main grooves 41 and sub-grooves 42. The main groove 41 is a groove that is provided with a wear indicator 44. The wear indicator 44 may be a protrusion provided in the groove. The sub-groove 42 is a groove that is not provided with the wear indicator 44. The main groove 41 may be referred to as a groove, and the sub-groove 42 may be referred to as a slit and/or a sipe. Typically, the depth of the sub-groove 42 may be shallower than the depth of the main groove 41.

The tire groove measuring device 1 of the present embodiment is a hand-held tire groove measuring device that is held by the user to be moved along the tread 31 of the tire 30 to measure the grooves 40. The tire groove measuring device 1 includes a distance sensor 21. The user can scan the tread 31 provided with the grooves 40 by moving the tire groove measuring device 1 along the surface of the tread 31 with the distance sensor 21 facing the tread 31. When scanning, the user moves the tire groove measuring device 1 along the surface of the tread 31 while keeping the tire groove measuring device 1 in contact with the tread 31. The tire groove measuring device 1 may also be moved without being in contact with the tread 31. The arrow 15 shows an example of the direction in which the tire groove measuring device 1 is moved. Note that the range of the tread 31 to be scanned using the tire groove measuring device 1 may include a part of the portion that connects together the tread 31 and the sidewall of the tire 30 (referred to also as the shoulder portion).

The distance sensor 21 is, for example, a laser distance sensor. The distance sensor 21 irradiates a laser beam onto the tread 31 provided with the grooves 40 and detects the distance between the tire 30 and the tire groove measuring device 1 by receiving the reflected light. The distance measuring method may be any method known in the art. While the distance measuring method may be a triangulation method, for example, the measurement method is not limited thereto. By using a laser distance sensor as the distance sensor 21, there is no need to insert a probe such as a gauge into grooves 40, and it is possible to measure the grooves 40 with high accuracy in a short time.

As described above, the tire groove measuring device 1 is a hand-held tire groove measuring device that the user moves along the tread 31 of the tire 30. The grooves 40 can be measured while the vehicle is stopped at an arbitrary location, and it is therefore possible to improve the user convenience.

As shown in FIG. 2, the tire groove measuring device 1 includes a processing device 10, the distance sensor 21, an inertial sensor 22, a display panel 23, a plurality of operation switches 24, a communication device 25, and a battery 26. The battery 26 supplies power to the components of the tire groove measuring device 1.

The processing device 10 includes a processor 11 and recording media such as a ROM (Read Only Memory) 12 and a RAM (Random Access Memory) 13. A computer program (or firmware) that causes the processor 11 to execute processes may be stored in the ROM 12. The computer program may be provided to the tire groove measuring device 1 via a storage medium (e.g., a semiconductor memory or an optical disc) or an electrical communication line (e.g., the Internet). Such a computer program may be sold as commercial software.

The processor 11 is a semiconductor integrated circuit, and includes a central processing unit (CPU), for example. The processor 11 sequentially executes the computer program stored in the ROM 12, which describes a group of instructions for executing various processes, to achieve desired processes.

The ROM 12 is, for example, a writable memory (e.g., a PROM), a rewritable memory (e.g., a flash memory), or a read-only memory. The ROM 12 stores a computer program that controls the operation of the processor 11. The RAM 13 provides a work area for temporarily expanding the computer program stored in the ROM 12 at boot time.

The processor 11 generates contour shape data representing the contour shape of the tire 30 based on the output data of the distance sensor 21.

The distance sensor 21 irradiates a laser beam onto the tread 31 provided with the grooves 40, and detects the distance between the tire 30 and the tire groove measuring device 1. The distance sensor 21 outputs data including information regarding the detected distance to the processor 11.

The inertial sensor 22 includes an acceleration sensor, an angular acceleration sensor, a magnetic sensor, etc., and outputs signals representing the amount of movement, the orientation, and the attitude. The inertial sensor 22 can output signals representing various quantities such as acceleration, speed, displacement, orientation, and attitude of the tire groove measuring device 1.

The tire groove measuring device 1 includes a plurality of operation switches 24. The tire groove measuring device 1 may include three or more operation switches 24. The user can operate the operation switches 24 to turn ON/OFF the power of the tire groove measuring device 1, perform an operation of starting and ending the scan, switch the display content of the display panel 23, exchange data with external devices, etc.

The display panel 23 displays various information in response to the user's operation of the tire groove measuring device 1. The display panel 23 is, for example, an LCD panel. The processor 11 causes the display panel 23 to display information such as the operating status of the tire groove measuring device 1, information representing the measurement results of the grooves 40, and the remaining battery capacity. The display panel 23 may be a display panel other than an LCD panel, such as an OLED (Organic Light-Emitting Diode) panel or an electronic paper panel.

The communication device 25 performs data communication between the tire groove measuring device 1 and an external device. For example, the communication device 25 transmits information regarding the contour shape of the tire 30 calculated by the processor 11 to the external device. The communication device 25 can perform wired communication and/or wireless communication. The communication device 25 can perform wired communication in accordance with communication standards such as USB, IEEE1394 (registered trademark), or Ethernet (registered trademark), for example. The communication device 25 can perform wireless communication in accordance with the Bluetooth (registered trademark) standard and/or the Wi-Fi (registered trademark) standard, for example. The communication device 25 may perform wireless communication using a mobile telephone line.

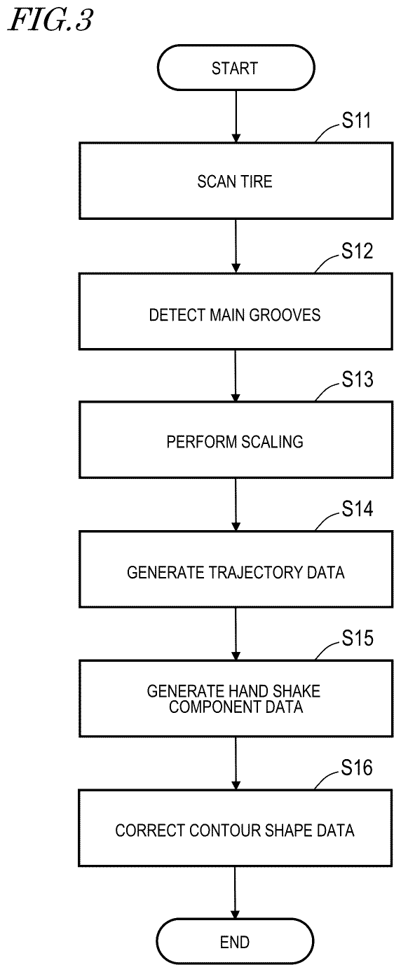

Next, the process of correcting the contour shape data 50 representing the contour shape of the tire 30 to reduce the discrepancy between the contour shape data 50 and the actual contour shape of the tire 30 will be described. FIG. 3 is a flow chart showing the process of correcting the contour shape data 50.

First, the tread 31 of the tire 30 provided with a plurality of grooves 40 is scanned (step S11). The scanning operation of the tread 31 is as described above using FIG. 1. During the scanning operation, the distance sensor 21 irradiates a laser beam onto the tread 31 provided with the grooves 40, and detects the distance between the tire 30 and the tire groove measuring device 1 by receiving the reflected light. The processor 11 uses the output data of the inertial sensor 22 to calculate the amount of movement of the tire groove measuring device 1 during the scanning operation and the degree of tilt of the tire groove measuring device 1. The processor 11 can obtain data on the distance between each position along the scan line on the tread 31 provided with the grooves 40 and the tire groove measuring device 1 using the output data of the distance sensor 21 and the inertial sensor 22.

The processor 11 can correct the output data of the distance sensor 21 based on the output data of the inertial sensor 22. By correcting the output data of the distance sensor 21 using the output data of the inertial sensor 22, it is possible to reduce the disturbance of the measurement data caused by vibration, hand shake, etc., of the tire groove measuring device 1 during the scan. The processor 11 generates the contour shape data representing the contour shape of the tire 30 using the output data of the distance sensor 21 and the inertial sensor 22. More specifically, the processor 11 generates the contour shape data representing the contour shape of a part of the tread 31 where the grooves 40 are provided.

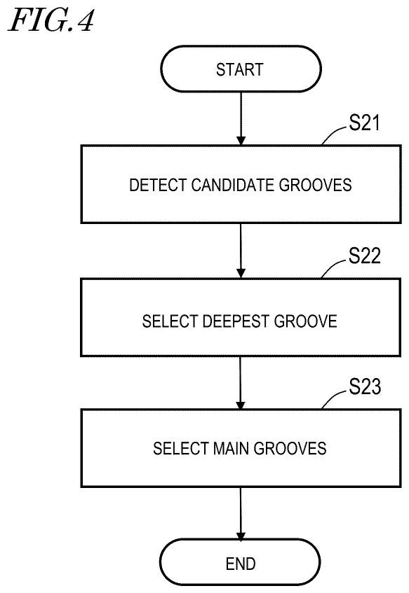

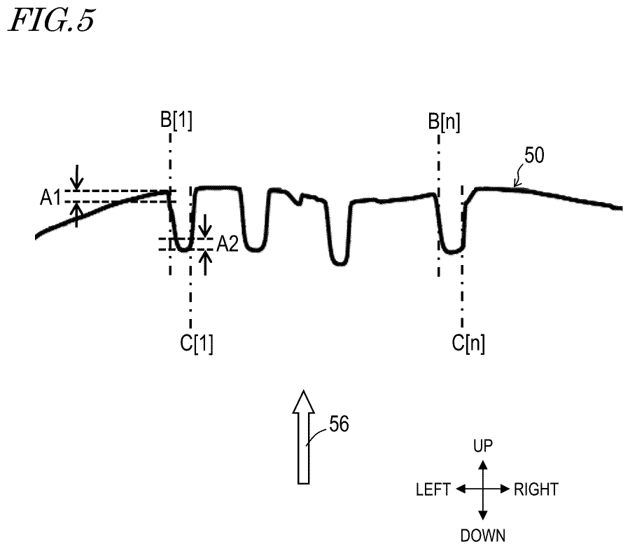

Next, the processor 11 detects the plurality of main grooves 41 from the contour shape data (step S12). FIG. 4 is a flow chart showing the process of detecting the plurality of main grooves 41 from the contour shape data. FIG. 5 is a view showing an example of the contour shape data 50 representing the contour shape of a part of the tread 31 where the grooves 40 are provided.

The left-right direction of the contour shape data 50 shown in the figure may be a direction that is generally along the surface of the tread 31 in the width direction of the tire 30. The up-down direction of the contour shape data 50 may be a direction that is generally along the radial direction of the tire 30. The height direction 56 is a direction that is along the up-down direction. A position with a smaller distance from the tire groove measuring device 1 can be a position with a larger height. The contour shape data 50 can represent the cross-sectional shape of the tread 31 along the scan line. The data on the distance between the tire 30 and the tire groove measuring device 1 can be used to obtain the relative height relationship between the tread 31 and the grooves 40. For the sake of clarity, the following description may focus on the height of the tread 31 and the height of each of the plurality of grooves 40.

The processor 11 detects candidate grooves 40 from the contour shape data 50 (step S21 in FIG. 4). FIG. 5 shows the process of detecting start edges and end edges of the grooves 40.

The processor 11 estimates, as the position of the start edge B[n] of the groove 40, the position where the increase in distance represented by the contour shape data 50 is equal to the predetermined value A1 (the second predetermined value) (n is an integer of 1 or more). An increase in distance represented by the contour shape data 50 corresponds to a decrease in height.

For example, the minimum value of the distance over a section of a predetermined length in the scanning direction (the left-right direction in FIG. 5) along the surface of the tread 31 is used as a reference, and the processor 11 estimates, as the position of the start edge B[n], the position where the increase from the reference distance is equal to the predetermined value A1. The section of the predetermined length is 0.5 mm to 1.0 mm, for example, but is not limited thereto. The predetermined value A1 is 0.2 mm to 1.0 mm, for example, but is not limited thereto. Here, the predetermined value A1 is 0.2 mm as an example.

The processor 11 estimates, as the position of the end edge C[n] of the groove 40, the position where the decrease in distance represented by the contour shape data 50 is equal to the predetermined value A2 (the third predetermined value). A decrease in distance represented by the contour shape data 50 corresponds to an increase in height.

For example, the maximum value of the distance over a section of a predetermined length in the scanning direction (the left-right direction in FIG. 4) along the surface of the tread 31 is used as a reference, and the processor 11 estimates, as the position of the end edge C[n], the position where the decrease from the reference distance is equal to the predetermined value A2. The predetermined value A2 is 0.2 mm to 1.0 mm, for example, but is not limited thereto. The predetermined value A1 and the predetermined value A2 may be the same value. Here, the predetermined value A2 is 0.2 mm as an example.

The processor 11 detects a plurality of start edges B[n] and end edges C[n] from the contour shape data 50. The area starting from the start edge B[n] and ending at the end edge C[n] can be a candidate groove 40.

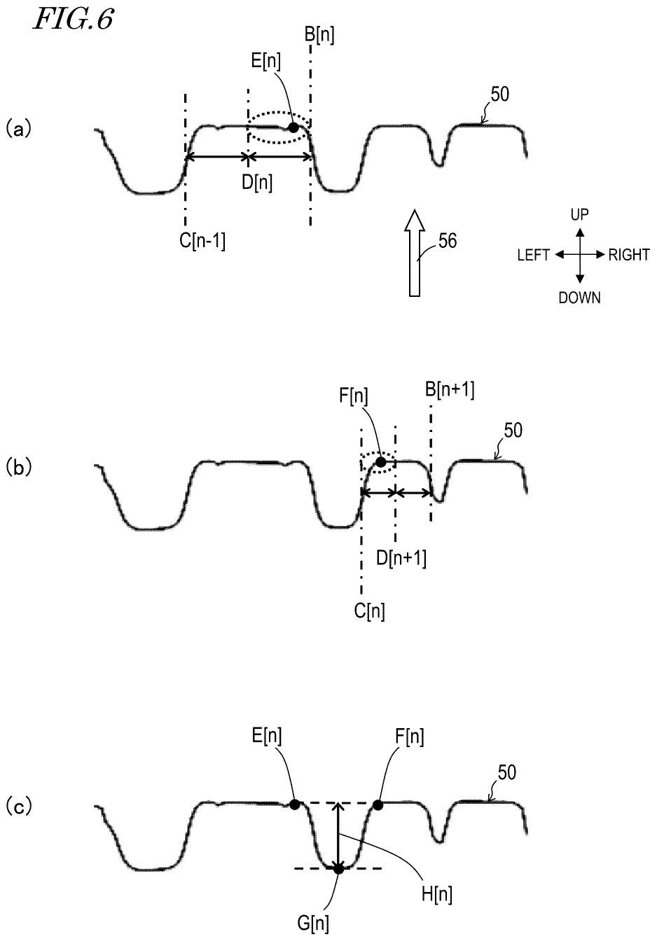

Next, the processor 11 calculates the depths of the candidate grooves 40. FIG. 6 is views showing the process of calculating the depths of the candidate grooves 40.

The processor 11 calculates the average value between the distance at the start edge B[n] and the distance at the end edge C[n] represented by the contour shape data 50. The processor 11 calculates, as the depth of the groove 40, the difference between the calculated average value and the distance value at a position between the start edge B[n] and the end edge C[n] where the distance is the greatest.

As shown in FIG. 6(a), the processor 11 calculates the position of the midpoint D[n] between the start edge B[n] of the groove 40 to be the subject of depth calculation and the preceding end edge C[n−1]. The processor 11 determines, as the distance value of the start edge B[n], the median or average value of distance for a section between the start edge B[n] and the midpoint D[n].

As shown in FIG. 6(b), the processor 11 calculates the position of the midpoint D[n+1] between the end edge C[n] of the groove 40 to be the subject of depth calculation and the following start edge B[n+1]. The processor 11 determines, as the distance value of the end edge C[n], the median or average value of distance for a section between the end edge C[n] and the midpoint D[n+1]. From the value calculated in this way, it is possible to calculate the average value between the distance at the start edge B[n] and the distance at the end edge C[n].

For the groove 40 located at the left end of the plurality of grooves 40 arranged along the tread 31, the position of the midpoint D[n] may be the position that is a predetermined distance away leftward from the start edge B[n]. For the groove 40 located at the right end of the plurality of grooves 40 arranged along the tread 31, the position of the midpoint D[n+1] may be the position that is a predetermined distance away rightward from the end edge C[n].

As shown in FIG. 6(c), the processor 11 extracts the distance value at the position G[n] between the start edge B[n] and the end edge C[n] where the distance is the greatest. The processor 11 calculates, as the depth H[n] of groove 40, the difference between the average value (between the distance at the start edge B[n] and the distance at the end edge C[n]) and the distance value at the position G[n]. By performing this process for each candidate groove 40, it is possible to calculate the depth of each candidate groove 40.

Next, the processor 11 selects the groove (the first groove) with the deepest depth from among the plurality of candidate grooves 40 (step S22 in FIG. 4). Using the value of the depth of the first groove, which is the deepest, the processor 11 selects main grooves 41 from among the plurality of candidate grooves 40 (step S23).

The processor 11 selects, as main grooves 41, grooves whose depth is within a predetermined value Q (the first predetermined value) with respect to the depth of the first groove from among a plurality of candidate grooves 40. The predetermined value Q is 1.5 mm to 2.0 mm, for example, but is not limited thereto. Here, the predetermined value Q is 1.6 mm as an example. By selecting, as the main grooves 41, grooves whose depth is within the predetermined value Q with respect to the depth of the first groove from among the plurality of candidate grooves 40, it is possible to suppress the erroneous detection of a sub-groove 42 whose depth is relatively shallow as the main groove 41.

Note that, at the point where the first groove with the greatest depth is selected in step S22, the process of detecting a plurality of candidate grooves 40 from the contour shape data 50 (step S21) may be performed again. In this case, the processor 11 updates the predetermined values A1 and A2 to the value obtained by multiplying the depth of the first groove by the first predetermined ratio. The first predetermined ratio is 30% to 50%, for example, but is not limited thereto. Here, the first predetermined ratio is 50% as an example. The processor 11 again executes the process of estimating the positions of the start edge B[n] and the end edge C[n] using the updated predetermined values A1 and A2.

The processor 11 updates a plurality of candidate grooves 40 based on the positions of the re-estimated start edge B[n] and end edge C[n]. By updating the plurality of candidate grooves 40, it is possible to more accurately select the main grooves 41. The processor 11 selects, as the main grooves 41, grooves whose depth is within the predetermined value Q with respect to the depth of the first groove from among the plurality of updated candidate grooves 40.

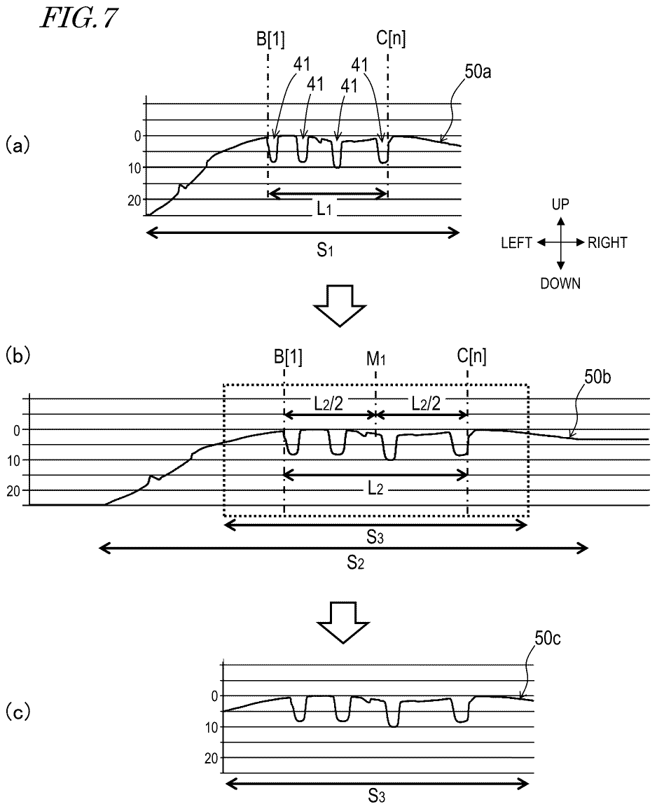

Next, the processor 11 scales the contour shape data 50 (step S13 in FIG. 3). FIG. 7 is views showing an example of the scaling process.

FIG. 7(a) shows contour shape data 50a generated by the processor 11. In the present embodiment, the processing focuses mainly on the main groove 41. While the contour shape data may also include the shape of the sub-groove 42, the sub-groove 42 is omitted in the example of the contour shape data shown in the figure in order to explain the features of the process of the present embodiment in an easy-to-understand manner.

The processor 11 detects the opposite ends of the group to which the plurality of main grooves 41 arranged along the tread 31 belong, based on the contour shape data 50a. Specifically, the processor 11 detects the main groove 41 located at the left end and the main groove 41 located at the right end from among the plurality of main grooves 41 arranged along the tread 31. The processor 11 detects the start edge B[1] of the main groove 41 located at the left end as the left end of the group. The processor 11 detects the end edge C[n] of the main groove 41 located at the right end as the right end of the group. The start edge and the end edge can be detected by the method described above using FIG. 5, for example.

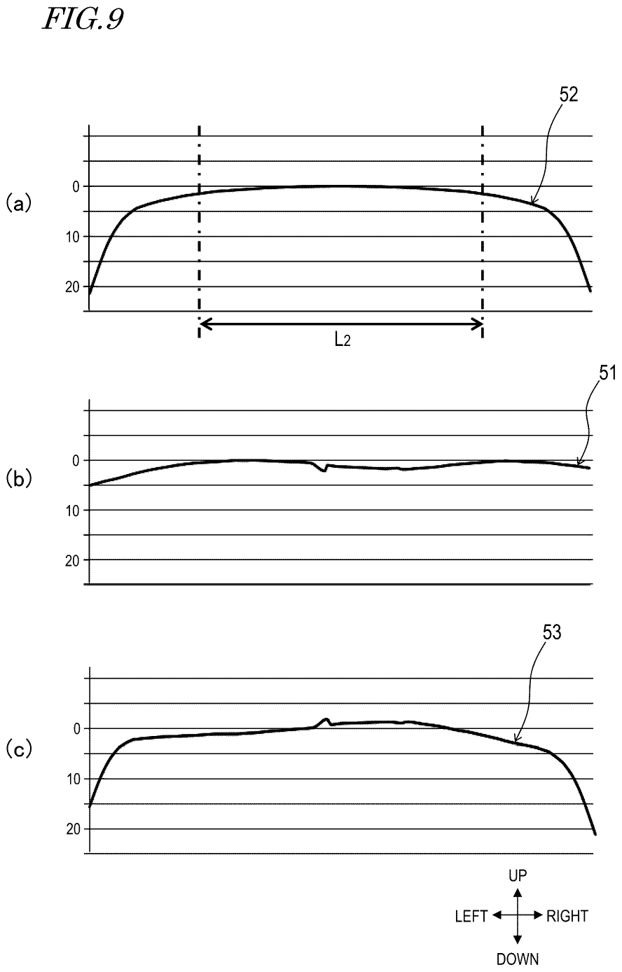

The processor 11 performs scaling so that the interval L₁ between the opposite ends of the group becomes equal to a predetermined interval L₂. FIG. 7(b) shows contour shape data 50b having been scaled. The predetermined interval L₂ is an interval that is pre-set in reference shape data 52 (FIG. 9) to be described below. Details of the reference shape data 52 will be described below.

For example, if the number of data samples for the predetermined interval L₂ pre-set in the reference shape data 52 is equal to a predetermined number of samples, the processor 11 performs scaling so that the number of data samples for the interval L₁ becomes equal to the predetermined number of samples. If the interval L₁ is smaller than the predetermined interval L₂, for example, up-conversion is performed on the contour shape data 50a so that the interval L₁ becomes equal to the predetermined interval L₂. If the interval L₁ is larger than the predetermined interval L₂, for example, down-conversion is performed on the contour shape data 50a so that the interval L₁ becomes equal to the predetermined interval L₂.

As shown in FIG. 7(b), by scaling, the sampling number S₁ of the entire contour shape data 50a becomes equal to the sampling number S₂ in the contour shape data 50b. The processor 11 determines the midpoint M₁ of the predetermined interval L₂. The processor 11 extracts an area that extends in the left-right direction from the midpoint M₁ where the sampling number is S3 to obtain contour shape data 50c shown in FIG. 7(c). The sampling number for the section from the left end of the contour shape data 50c to the midpoint M₁ is S3/2. The sampling number from the right edge of the contour shape data 50c to the midpoint M₁ is S3/2. The sampling number S₃ is equivalent to the sampling number of the reference shape data 52 (FIG. 9), for example. By setting the sampling number of the contour shape data 50c to a value that is the same as or close to the sampling number of the reference shape data 52, the processing can be performed smoothly.

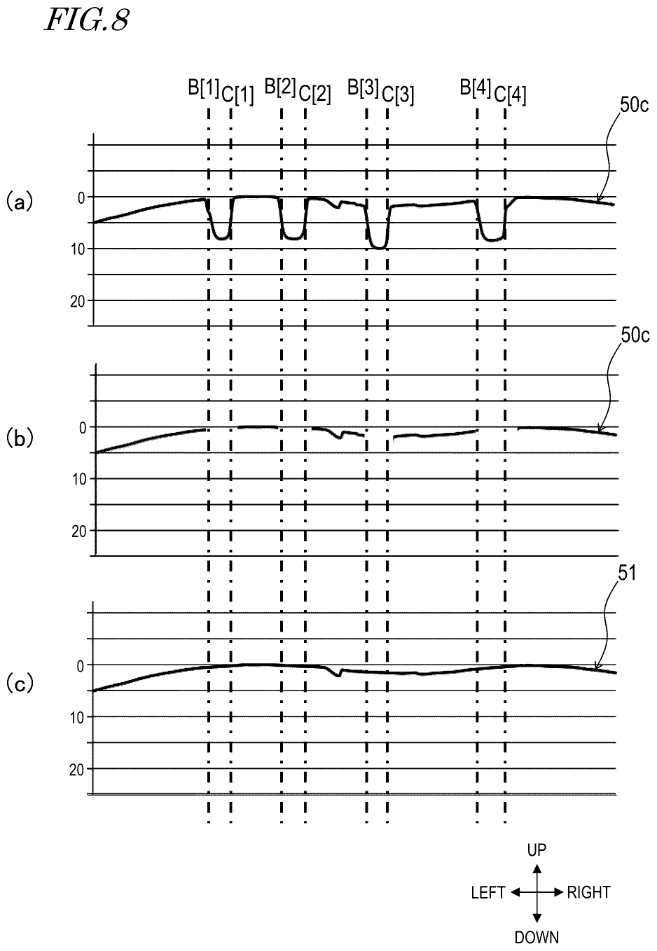

Next, the processor 11 generates trajectory data representing the trajectory of movement of tire groove measuring device 1 (step S14 in FIG. 3). FIG. 8 is a view showing an example of the process of generating trajectory data 51.

FIG. 8(a) shows the contour shape data 50c. The processor 11 deletes portions of the contour shape data 50c corresponding to the main grooves 41 as shown in FIG. 8(b). The start edge B[n] and the end edge C[n] of each main groove 41 can be detected by the method described above using FIG. 5, for example.

The processor 11 deletes the data of the section between the start edge and the end edge of each main groove 41. For each main groove 41, the data of the section between a position that is a predetermined distance away leftward from the start edge and a position that is a predetermined distance away rightward from the end edge may be deleted. Thus, the edge portions of each main groove 41 can be deleted appropriately.

For the contour shape data 50c whose portions corresponding to the main grooves 41 have been deleted, the processor 11 performs the process of interpolating each of the deleted sections, as shown in FIG. 8(c) to generate the trajectory data 51 representing the trajectory of movement of the tire groove measuring device 1. As the method for interpolation, for example, each section between the start edge and the end edge may be interpolated with a straight line, or may be interpolated with a curve.

The data (i.e., the trajectory data 51) that is obtained by interpolating the deleted portions corresponding to the main grooves 41 in the contour shape data 50c whose portions corresponding to the main grooves 41 have been deleted represents a shape that extends generally along the trajectory of movement of the tire groove measuring device 1 scanning the tire 30.

Next, the processor 11 generates hand shake component data representing the hand shake component generated by the user moving the tire groove measuring device 1 by hand (step S15 in FIG. 3). FIG. 9 is views showing an example of the process of generating hand shake component data 53.

FIG. 9(a) shows the reference shape data 52 representing the contour shape of a reference tire 30 prepared in advance. The reference shape data 52 is stored in advance in the ROM 12 (FIG. 2), for example. The reference shape data 52 representing the contour shape of the tread 31 where it is assumed that no groove 40 is provided in the tire 30.

FIG. 9(b) shows the trajectory data 51. The processor 11 compares the trajectory data 51 with the reference shape data 52 to generate the hand shake component data 53 shown in FIG. 9(c). The processor 11 can generate the hand shake component data 53 by calculating the difference between the reference shape data 52 and the trajectory data 51, for example.

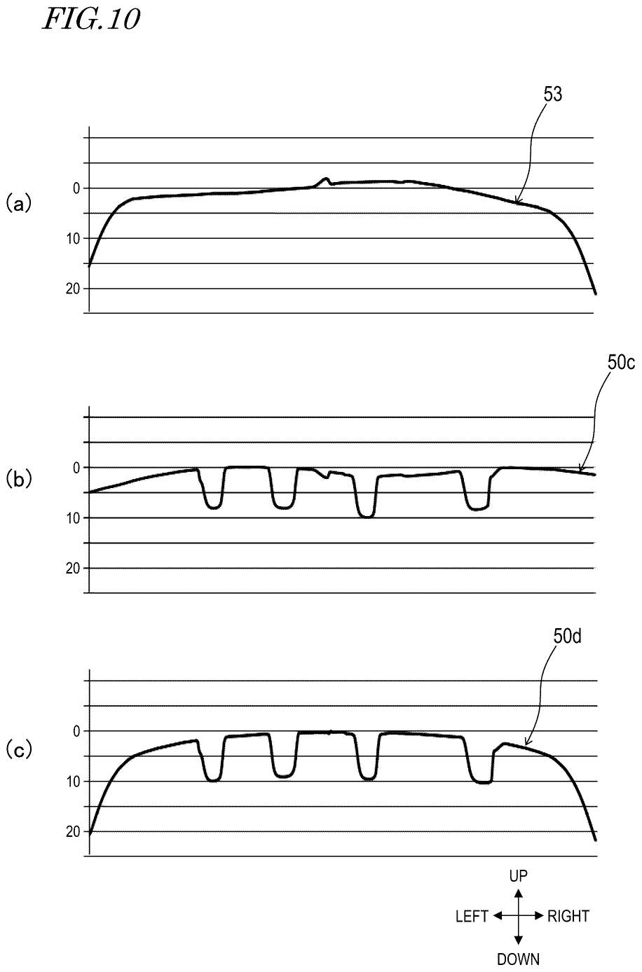

Next, the processor 11 corrects the contour shape data 50c (FIG. 8(a) before deletion of the portions corresponding to the main grooves 41 (step S16 in FIG. 3). FIG. 10 is views showing an example of the process of correcting the contour shape data 50c before deletion of the portions corresponding to the main grooves 41.

FIG. 10(a) shows the hand shake component data 53. FIG. 10(b) shows the contour shape data 50c before deletion of the portions corresponding to the main grooves 41. The processor 11 corrects the contour shape data 50c before deletion of the portions corresponding to the main grooves 41 using the hand shake component data 53. For example, the processor 11 corrects the contour shape data 50c by adding the hand shake component data 53 to the contour shape data 50c. By correcting the contour shape data 50c using the hand shake component data 53, the contour shape data 50d from which the hand shake component has been removed is obtained. FIG. 10(c) shows the contour shape data 50d from which the hand shake component has been removed.

When measuring the tire 30 with the hand-held tire groove measuring device 1, the user moves the tire groove measuring device 1 by hand. Therefore, a discrepancy may occur between the contour shape data 50c obtained from the output data of the distance sensor 21 and the actual contour shape of the tire 30.

According to the present embodiment, the trajectory data 51 representing the trajectory of movement of the tire groove measuring device 1 is generated based on the contour shape data 50c obtained from the output data of the distance sensor 21, and the hand shake component data 53 is generated using the trajectory data 51. By correcting the contour shape data 50c using the generated hand shake component data 53, it is possible to reduce the discrepancy between the contour shape data 50c and the actual contour shape of the tire 30. Thus, it is possible to obtain the contour shape data 50d representing a shape that is closer to the actual contour shape of the tire 30. By using the contour shape data 50d, it is possible to present, to the user, a shape that is closer to the actual contour shape of the tire 30. In addition, by using the contour shape data 50d, it is possible to accurately grasp the state of the main grooves 41 provided in the tire 30.

According to the present embodiment, even when correction is performed using the output data of the inertial sensor 22, it is possible to reduce the vibration and hand shake components that remain after the correction using the output data of the inertial sensor 22.

Note that if the shape of the sub-groove 42 is included in the contour shape data 50a (FIG. 7(a)), the shape of the sub-groove 42 remains as a hand shake component. As described above, in the process of correcting the contour shape data 50c using the hand shake component data 53, the shape of the sub-groove 42 is canceled out and does not appear in the contour shape data 50d. As the shape of the sub-groove 42 is not displayed, it is easier to recognize the shape of the main groove 41, which is more important.

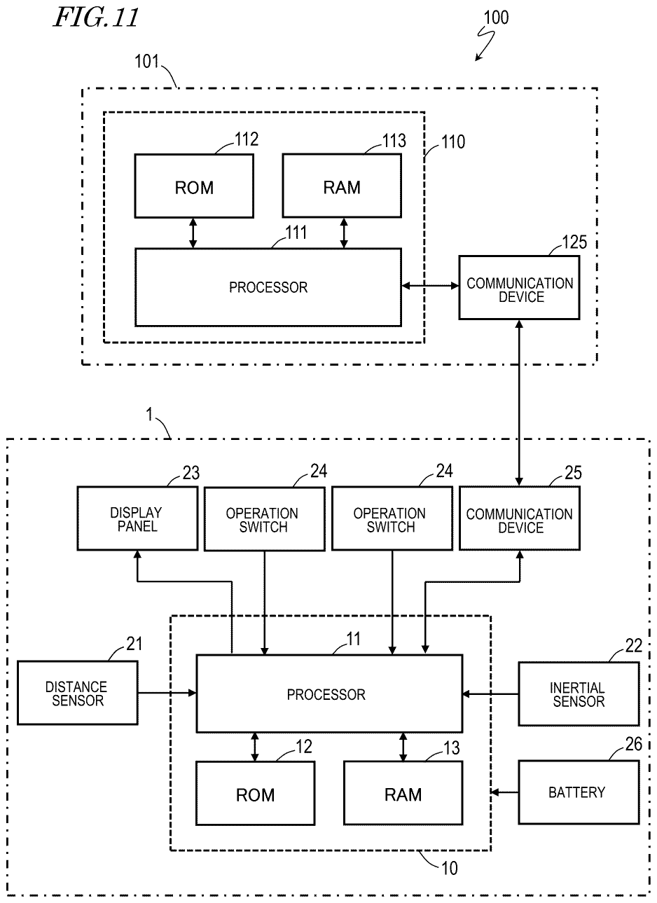

Note that the process of the processor 11 described above may be executed by a device external to the tire groove measuring device 1. FIG. 11 is a block diagram showing a tire groove measuring system 100 according to an embodiment of the present invention.

The tire groove measuring system 100 includes the tire groove measuring device 1 and an external device 101. The external device 101 is, for example, a server computer or a user terminal device. The user terminal device is, for example, a personal computer or a tablet computer.

The external device 101 includes a processing device 110 and a communication device 125. The processing device 110 includes a processor 111 and storage media such as a ROM 112 and a RAM 113. The description of the processor 111, the ROM 112, the RAM 113, and the communication device 125 is omitted here because it is redundant with the description of the processor 11, the ROM 12, the RAM 13, and the communication device 25 of the tire groove measuring device 1.

The processor 111 of the external device 101 performs the process of the processor 11 described above. Thus, the same effect as the above can be obtained.

The processor 111 may estimate, using an estimation model generated by machine learning, the quality of the contour shape data 50d having been corrected using the hand shake component data 53.

For example, the external device 101 is provided with a memory device that stores a plurality of sets of contour shape data each representing the contour shape of a tire and having a pre-specified quality. The memory device may be a hard disk drive (HDD), a solid state drive (SSD), a cloud storage, etc. The memory device may be the ROM 112.

The processor 111 or another processor uses a plurality of sets of contour shape data stored in the memory device as training data, and generates an estimation model using machine learning, where the input is the contour shape data and the output is the quality of the contour shape data. The training data includes, for example, contour shape data that was successfully generated and contour shape data that was unsuccessfully generated.

The processor 111 or another processor can estimate, using the estimation model, the quality of the contour shape data 50d having been corrected using the hand shake component data 53. For example, by estimating the quality of the contour shape data 50d using the estimation model, it is possible to determine whether the generation of the contour shape data 50d has been successful or unsuccessful. By using the estimation model generated by machine learning, it is possible to easily estimate the quality of the contour shape data 50d having been corrected.

The estimation of the quality of the contour shape data 50d using the estimation model may be performed by the processor 11 of the tire groove measuring device 1. Alternatively, a processor installed on a device other than the tire groove measuring device 1 and the external device 101 may perform the generation of the estimation model and/or the estimation of the quality of the contour shape data 50d using the estimation model.

While the tire groove measuring device 1 is of a hand-held type in the description of the embodiment above, the tire groove measuring device 1 may be a stationary type. In a form where the tire groove measuring device 1 is fixed in an arbitrary location, even if the positional relationship between the tire groove measuring device 1 and the tire 30 is misaligned, it is possible to generate the contour shape data 50d with a reduced amount of misalignment.

An embodiment of the present invention has been described above.

A tire groove measuring device 1 according to an embodiment of the present invention is a hand-held tire groove measuring device 1 that a user moves along a tread 31 of a tire 30 to be measured for measuring grooves 40 provided in the tread 31 of the tire 30, including: a distance sensor 21 that detects a distance between the tire 30 and the tire groove measuring device 1; and a processing device 10 that generates contour shape data 50 representing a contour shape of the tire 30 based on output data of the distance sensor 21. The tread 31 of the tire 30 is provided with main grooves 41 having a wear indicator 44. The processing device 10 is configured to: detect the main grooves 41 based on the contour shape data 50; delete portions of the contour shape data 50 corresponding to the main grooves 41; interpolate the deleted portions corresponding to the main grooves 41 in the contour shape data 50 whose portions corresponding to the main grooves 41 have been deleted, thereby generating trajectory data 51 representing a trajectory of movement of the tire groove measuring device 1; compare the trajectory data 51 with reference shape data 52 representing a contour shape of a reference tire 30 prepared in advance to generate hand shake component data 53 representing a hand shake component; and correct the contour shape data 50 before deletion of the portions corresponding to the main grooves 41 using the hand shake component data 53.

With the hand-held tire groove measuring device 1, since the user moves the tire groove measuring device 1 by hand when measuring the tire 30, a discrepancy may occur between the contour shape data 50 obtained from the output data of the distance sensor 21 and the actual contour shape of the tire 30.

According to an embodiment of the present invention, the trajectory data 51 representing the trajectory of movement of the tire groove measuring device 1 is generated based on the contour shape data 50 obtained from the output data of the distance sensor 21, and the hand shake component data 53 is generated using the trajectory data 51. By correcting the contour shape data 50 using the generated hand shake component data 53, it is possible to reduce the discrepancy between the contour shape data 50 and the actual contour shape of the tire 30. Thus, it is possible to obtain the contour shape data 50 representing a shape that is closer to the actual contour shape of the tire 30.

In one embodiment, the processing device 10 may be configured to: detect opposite ends B[1], C[n] of a group of main grooves 41 arranged along the tread 31; and delete the portions corresponding to the main grooves 41 of the contour shape data 50 having been scaled so that an interval L₁ between the opposite ends becomes equal to a predetermined interval L₂, and perform the interpolation to generate the trajectory data 51.

Thus, it is possible to generate the trajectory data 51 of a size that is suitable for comparison with the reference shape data 52.

In one embodiment, the processing device 10 may be configured to generate the hand shake component data 53 by calculating a difference between the reference shape data 52 and the trajectory data 51.

Thus, it is possible to generate the hand shake component data 53 from the reference shape data 52 and the trajectory data 51.

In one embodiment, the processing device 10 may be configured to correct the contour shape data 50 before deletion of the portions corresponding to the main grooves 41 by adding the hand shake component data 53 to the contour shape data 50 before deletion of the portions corresponding to the main grooves 41.

Thus, it is possible to obtain the contour shape data 50 representing a shape that is closer to the actual contour shape of the tire 30.

In one embodiment, the processing device 10 may be configured to: detect a plurality of candidate grooves 40 based on the contour shape data 50 generated based on the output data of the distance sensor 21; select a first groove 40 with a greatest depth from among the plurality of candidate grooves 40; and detect, as main grooves 41, grooves whose depth is within a first predetermined value with respect to the depth of the first groove 40 from among the plurality of candidate grooves 40.

Thus, it is possible to detect the main grooves 41 from among the plurality of grooves 40.

In one embodiment, the processing device 10 may be configured to estimate, as a position of a start edge B[n] of a groove 40, a position where an increase in distance represented by the contour shape data 50 generated based on the output data of the distance sensor 21 is equal to a second predetermined value A1, and estimate, as a position of an end edge C[n] of a groove 40, a position where a decrease in distance represented by the output data is equal to a third predetermined value A2.

Thus, it is possible to detect candidate grooves 40 using the contour shape data 50.

In one embodiment, the processing device 10 may be configured to: calculate an average value between a distance at the start edge and a distance at the end edge; and calculate, as a depth H[n] of a groove 40, a difference between the average value and a distance at a position between the start edge and the end edge where the distance is greatest.

Thus, it is possible to calculate the depths of the candidate grooves 40.

In one embodiment, the distance sensor 21 may be a laser distance sensor.

Thus, there is no need to insert a probe such as a gauge into the grooves 40 of the tire 30, and it is possible to measure the grooves 40 of the tire 30 with high accuracy in a short time.

In one embodiment, the processing device 10 may be configured to estimate, using an estimation model generated by machine learning, a quality of the contour shape data 50 having been corrected using the hand shake component data 53.

By using the estimation model generated by machine learning, it is possible to easily estimate the quality of the contour shape data 50 having been corrected.

A tire groove measuring system 100 according to an embodiment of the present invention is a tire groove measuring system 100 using a hand-held tire groove measuring device 1 that a user moves along a tread 31 of a tire 30 to be measured for measuring grooves 40 provided in the tread 31 of the tire 30, including: a distance sensor 21 provided in the tire groove measuring device 1 that detects a distance between the tire 30 and the tire groove measuring device 1; and a processing device 10, 110 that generates contour shape data 50 representing a contour shape of the tire 30 based on output data of the distance sensor 21. The tread 31 of the tire 30 is provided with main grooves 41 having a wear indicator 44. The processing device 10, 110 is configured to: detect the main grooves 41 based on the contour shape data 50; delete portions of the contour shape data 50 corresponding to the main grooves 41; interpolate the deleted portions corresponding to the main grooves 41 in the contour shape data 50 whose portions corresponding to the main grooves 41 have been deleted, thereby generating trajectory data 51 representing a trajectory of movement of the tire groove measuring device 1; compare the trajectory data 51 with reference shape data 52 representing a contour shape of a reference tire 30 prepared in advance to generate hand shake component data 53 representing a hand shake component; and correct the contour shape data 50 before deletion of the portions corresponding to the main grooves 41 using the hand shake component data 53.

With the hand-held tire groove measuring device 1, since the user moves the tire groove measuring device 1 by hand when measuring the tire 30, a discrepancy may occur between the contour shape data 50 obtained from the output data of the distance sensor 21 and the actual contour shape of the tire 30.

According to an embodiment of the present invention, the trajectory data 51 representing the trajectory of movement of the tire groove measuring device 1 is generated based on the contour shape data 50 obtained from the output data of the distance sensor 21, and the hand shake component data 53 is generated using the trajectory data 51. By correcting the contour shape data 50 using the generated hand shake component data 53, it is possible to reduce the discrepancy between the contour shape data 50 and the actual contour shape of the tire 30. Thus, it is possible to obtain the contour shape data 50 representing a shape that is closer to the actual contour shape of the tire 30.

In one embodiment, the processing device 10, 110 may be configured to estimate, using an estimation model generated by machine learning, a quality of the contour shape data 50 having been corrected using the hand shake component data 53.

By using the estimation model generated by machine learning, it is possible to easily estimate the quality of the contour shape data 50 having been corrected.

A tire groove measuring method according to an embodiment of the present invention is a tire groove measuring method using a hand-held tire groove measuring device 1 that a user moves along a tread 31 of a tire 30 to be measured for measuring grooves 40 provided in the tread 31 of the tire 30. The tread 31 of the tire 30 is provided with main grooves 41 having a wear indicator 44. The tire groove measuring method includes: detecting a distance between the tire 30 and the tire groove measuring device 1 using a distance sensor 21; generating contour shape data 50 representing a contour shape of the tire 30 based on output data of the distance sensor 21; detecting main grooves 41 based on the contour shape data 50; deleting portions of the contour shape data 50 corresponding to the main grooves 41; interpolating the deleted portions corresponding to the main grooves 41 in the contour shape data 50 whose portions corresponding to the main grooves 41 have been deleted, thereby generating trajectory data 51 representing a trajectory of movement of the tire groove measuring device 1; comparing the trajectory data 51 with reference shape data 52 representing a contour shape of a reference tire 30 prepared in advance to generate hand shake component data 53 representing a hand shake component; and correcting the contour shape data 50 before deletion of the portions corresponding to the main grooves 41 using the hand shake component data 53.

With the hand-held tire groove measuring device 1, since the user moves the tire groove measuring device 1 by hand when measuring the tire 30, a discrepancy may occur between the contour shape data 50 obtained from the output data of the distance sensor 21 and the actual contour shape of the tire 30.

According to an embodiment of the present invention, the trajectory data 51 representing the trajectory of movement of the tire groove measuring device 1 is generated based on the contour shape data 50 obtained from the output data of the distance sensor 21, and the hand shake component data 53 is generated using the trajectory data 51. By correcting the contour shape data 50 using the generated hand shake component data 53, it is possible to reduce the discrepancy between the contour shape data 50 and the actual contour shape of the tire 30. Thus, it is possible to obtain the contour shape data 50 representing a shape that is closer to the actual contour shape of the tire 30.

In one embodiment, the tire groove measuring method may further include estimating, using an estimation model generated by machine learning, a quality of the contour shape data 50 having been corrected using the hand shake component data 53.

By using the estimation model generated by machine learning, it is possible to easily estimate the quality of the contour shape data 50 having been corrected.

The description of the embodiment above merely illustrates the present invention and does not limit the present invention. Other embodiments are possible that each employ a combination of elements described in the embodiment above. Modifications, replacements, additions, omissions, etc., can be made to the present invention without departing from the scope defined by the claims and equivalents thereto.

### INDUSTRIAL APPLICABILITY

This invention is particularly useful in the technical field of tire groove measurement.

### REFERENCE SIGNS LIST

1 tire groove measuring device
10 processing device
11 processor
12 ROM
13 RAM
21 distance sensor
22 inertia sensor
23 display panel
24 operation switch
25 communication device
26 battery
30 tire
31 tread
40 groove
41 main groove
42 sub-groove
44 wear indicator
50 contour shape data
51 trajectory data
52 reference shape data
53 hand shake component data
100 tire groove measuring system
101 external device
110 processing device
111 processor
112 ROM
113 RAM
125 communication device

1. A hand-held tire groove measuring device that a user moves along a tread of a tire to be measured for measuring grooves provided in the tread of the tire, comprising:
a distance sensor that detects a distance between the tire and the tire groove measuring device; and
a processor that generates contour shape data representing a contour shape of the tire based on output data of the distance sensor, wherein:
the tread of the tire is provided with main grooves having a wear indicator; and
the processor is configured to:
detect main grooves based on the contour shape data;
delete portions of the contour shape data corresponding to the main grooves;
interpolate the deleted portions corresponding to the main grooves in the contour shape data whose portions corresponding to the main grooves have been deleted, thereby generating trajectory data representing a trajectory of movement of the tire groove measuring device;
compare the trajectory data with reference shape data representing a contour shape of a reference tire prepared in advance to generate hand shake component data representing a hand shake component; and
correct the contour shape data before deletion of the portions corresponding to the main grooves using the hand shake component data.

2. The tire groove measuring device according to claim 1, wherein:
the processor is configured to:
detect opposite ends of a group of the main grooves arranged along the tread; and
delete the portions corresponding to the main grooves of the contour shape data having been scaled so that an interval between the opposite ends becomes equal to a predetermined interval, and perform the interpolation to generate the trajectory data.

3. The tire groove measuring device according to claim 1, wherein the processor is configured to generate the hand shake component data by calculating a difference between the reference shape data and the trajectory data.

4. The tire groove measuring device according to claim 1, wherein the processor is configured to correct the contour shape data before deletion of the portions corresponding to the main grooves by adding the hand shake component data to the contour shape data before deletion of the portions corresponding to the main grooves.

5. The tire groove measuring device according to claim 1, wherein:
the processor is configured to:
detect a plurality of candidate grooves based on the contour shape data generated based on the output data of the distance sensor;
select a first groove with a greatest depth from among the plurality of candidate grooves; and
detect, as main grooves, grooves whose depth is within a first predetermined value with respect to the depth of the first groove from among the plurality of candidate grooves.

6. The tire groove measuring device according to claim 5, wherein the processor is configured to estimate, as a position of a start edge of a groove, a position where an increase in distance represented by the contour shape data generated based on the output data of the distance sensor is equal to a second predetermined value, and estimate, as a position of an end edge of a groove, a position where a decrease in distance represented by the output data is equal to a third predetermined value.

7. The tire groove measuring device according to claim 6, wherein:
the processor is configured to:
calculate an average value between a distance at the start edge and a distance at the end edge; and
calculate, as a depth of a groove, a difference between the average value and a distance at a position between the start edge and the end edge where the distance is greatest.

8. The tire groove measuring device according to claim 1, wherein the distance sensor is a laser distance sensor.

9. The tire groove measuring device according to claim 1, wherein the processor is configured to estimate, using an estimation model generated by machine learning, a quality of the contour shape data having been corrected using the hand shake component data.

10. A tire groove measuring system using a hand-held tire groove measuring device that a user moves along a tread of a tire to be measured for measuring grooves provided in the tread of the tire, comprising:
a distance sensor provided in the tire groove measuring device that detects a distance between the tire and the tire groove measuring device; and
a processor that generates contour shape data representing a contour shape of the tire based on output data of the distance sensor, wherein:
the tread of the tire is provided with main grooves having a wear indicator; and
the processor is configured to:
detect main grooves based on the contour shape data;
delete portions of the contour shape data corresponding to the main grooves;
interpolate the deleted portions corresponding to the main grooves in the contour shape data whose portions corresponding to the main grooves have been deleted, thereby generating trajectory data representing a trajectory of movement of the tire groove measuring device;
compare the trajectory data with reference shape data representing a contour shape of a reference tire prepared in advance to generate hand shake component data representing a hand shake component; and
correct the contour shape data before deletion of the portions corresponding to the main grooves using the hand shake component data.

11. The tire groove measuring system according to claim 10, wherein the processor is configured to estimate, using an estimation model generated by machine learning, a quality of the contour shape data having been corrected using the hand shake component data.

12. A tire groove measuring method using a hand-held tire groove measuring device that a user moves along a tread of a tire to be measured for measuring grooves provided in the tread of the tire, wherein:
the tread of the tire is provided with main grooves having a wear indicator; and
the tire groove measuring method comprises:
detecting a distance between the tire and the tire groove measuring device using a distance sensor;
generating contour shape data representing a contour shape of the tire based on output data of the distance sensor;
detecting main grooves based on the contour shape data;
deleting portions of the contour shape data corresponding to the main grooves;
interpolating the deleted portions corresponding to the main grooves in the contour shape data whose portions corresponding to the main grooves have been deleted, thereby generating trajectory data representing a trajectory of movement of the tire groove measuring device;
comparing the trajectory data with reference shape data representing a contour shape of a reference tire prepared in advance to generate hand shake component data representing a hand shake component; and
correcting the contour shape data before deletion of the portions corresponding to the main grooves using the hand shake component data.

13. The tire groove measuring method according to claim 12, further comprising estimating, using an estimation model generated by machine learning, a quality of the contour shape data having been corrected using the hand shake component data.
